(19) United States
(12) Patent Application Publication
(10) Pub. No.: US 2024/0133551 A1
(43) Pub. Date: Apr. 25, 2024

(54) OXY-FUEL BURNER, IGNITION AND FLAME CONTROL SYSTEM AND METHOD FOR CONTROLLING IGNITION AND FLAME

(71) Applicant: L'Air Liquide, Société Anonyme pour l'Etude et l'Exploitation des Procédés Georges Claude, Paris (FR)

(72) Inventors: Ayrat ABUTALIPOV, Moscow (RU); Ivan CHERNYSHEV, Moscow (RU); Bertrand LEROUX, Voisins-le-Bretonneux (FR); Maxim MISYURA, Moscow (RU); Artem SHOVKAN, Zelenograd (RU); Lahcen OUGARANE, Jouy-en-Josas (FR); Xavier PAUBEL, Montigny-le-Bretonneux (FR)

(21) Appl. No.: 18/277,854

(22) PCT Filed: Mar. 1, 2022
(86) PCT No.: PCT/EP2022/055107

§ 371 Date: Aug. 17, 2023

(30) Foreign Application Priority Data
Mar. 2, 2021 (RU) 2021105389

(51) Int. Cl. F23N 5/12; F23D 14/22

(52) U.S. Cl. CPC F23N 5/123; F23D 14/22

(57) ABSTRACT

An oxy-fuel burner and method of use, having a housing defining an oxidizing-agent supply channel running in the longitudinal direction to the downstream end of the housing, a fuel supply channel likewise running in the longitudinal direction of the housing and an oxidant injector running in the longitudinal direction inside the fuel supply channel as well as an ignition and flame-control electrode inside the oxidizing-agent supply channel, the ignition and flame-control electrode being designed to provide initial ignition of the burner and subsequent control of the flame, and being connectable to a system for automatically controlling burner ignition and flame control.

### CROSS REFERENCE TO RELATED APPLICATIONS

This application is a 371 of International Application No. PCT/EP2022/055107, filed Mar. 1, 2022, which claims priority to Russian Patent Application No. 2021 105389, filed Mar. 2, 2021, the entire contents of which are incorporated herein by reference.

### BACKGROUND

### Field of the Invention

The invention relates to an oxy-fuel burner for a melting furnace, specifically to an oxy-fuel burner suitable for a shaft furnace for the manufacture of mineral wool, and its use. The invention also relates to a system and a method for controlling the ignition and flame control of such a burner.

### Prior Art

The mineral wool manufacturing process includes the obtaining of a raw material melt (for instance, basalt or dolomite) and the subsequent transformation of said melt into fibres, from which a mineral wool sheet is then typically formed. The melt is obtained by melting raw material in special shaft furnaces (cupola furnaces). Coke is used as the fuel for the shaft furnaces, said coke being mixed with a charge material and loaded into the furnace. Oxygen, present in the air, acts as the oxidizing agent which is necessary for the combustion process, said oxygen being supplied through tuyeres located on the side walls of the furnace.

The price of coke is relatively high. Moreover, certain geographic regions do not have accessible deposits of coking coal or the local coke is not always of the required quality, which forces mineral wool manufacturers to purchase coke from abroad. In that case, the costs incurred on this type of fuel account for a significant proportion of the costs required to manufacture mineral wool.

One of the known methods of reducing costs associated with the manufacture of mineral wool using cupola furnaces is to increase the oxygen content in the flow of air supplied to the furnace—oxygen enhancement technology. Said technology involves the supply of oxygen, either into the main flow of air supplied to the furnace, or directly into each tuyere, and makes it possible, in particular, to increase the rate at which melting of the raw material occurs, and to reduce coke consumption and the volume of exhaust gases. Oxygen enhancement technology is described, for instance, in the document/1/“Oxygen-enhanced combustion”/Edited by Charles E. Baukal, Jr., CRC Press, 1998.

However, when said technology is used, expensive coke remains the main fuel used in the process of manufacturing mineral wool.

Another solution, used for the purpose of reducing coke consumption, involves partially replacing said coke with a cheaper fuel, such as natural gas. In hot-blast cupola furnaces used in the production of cast iron, one technology is thus successfully used, whereby a “natural gas-oxygen” gas-oxygen burner is fitted directly into a tuyere, or above said tuyere, for the purpose of replacing a proportion of the energy obtained as a result of coke combustion, with energy resulting from the combustion of a mixture of natural gas and oxygen. Generally speaking, such an approach reduces coke consumption by up to 10%, and increases the melting rate and the percentage of hydrogen in the exhaust gases. At the same time, fitting a burner above the tuyere necessitates a complicated redesign of the furnace.

A design of gas-oxygen burner which can be fitted in the wall of an iron-melting furnace is known, for instance, from document/2/U.S. Pat. No. 6,089,858, publication date 18 Jul. 2000. Such a burner has an upstream end and a downstream end and comprises a housing which runs in the longitudinal direction and defines an oxidizing-agent supply channel running to the downstream end of the burner and opening into an oxidizing-agent outlet port at the downstream end, as well as a plurality of fuel supply channels running in said longitudinal direction and located inside the oxidizing-agent supply channel, wherein each fuel supply channel opens out at the downstream end of the burner.

However, said document does not contain information concerning the possibility of using such burners in shaft furnaces, specifically in shaft furnaces for the manufacture of mineral wool.

Another similar solution is described in document/3/US 2010/0186552, publication date 29 Jul. 2010, and relates to a shaft furnace, specifically to a cupola furnace, for the melting of feedstock. The furnace is heated using combustion of solid fuel, wherein an injection gas containing 21% oxygen is additionally supplied to the furnace. The furnace is also heated by at least one burner to which a gaseous or liquid fuel and a gaseous oxidizing agent are supplied. Although the above-referenced document relates to furnaces for the production of cast iron, said document mentions the possibility of using the technical solution disclosed therein additionally in furnaces for the manufacture of mineral wool. Therefore, the indicated document proposes a solution which represents a combination of oxygen enhancement technology and the use of oxy-fuel burners to replace a proportion of the energy, obtained as a result of coke combustion, with energy resulting from the combustion of a cheaper fuel. However, said document proposes alternately equipping the furnace tuyeres either with an oxygen injector or with an oxy-fuel burner, which would necessitate complex work being carried out in order to equip the tuyeres with one or other of the devices mentioned.

Furthermore, the total number of burners/injectors with which the furnace can be equipped represents half the number of furnace tuyeres, thereby reducing the flexibility of the production process when compared to the use of a furnace in which the number of burners/injectors would be equal to the number of tuyeres.

It is also worth noting that the aforementioned documents do not contain any information regarding equipping of the burners with automatic ignition and flame-control devices, the inclusion of which would make it possible to increase the efficiency of a shaft furnace and which is important in terms of ensuring the safe operation of the shaft furnace.

Devices used for automatic ignition and flame control of burners are themselves known from the prior art. Such devices are described, for instance, in document/4/“Pribory kontrolya plameni i upravleniya rozzhigom” //URL: https://www.promav.ru/production/pribory-kontrolya-plameni-i-upravlenie-rozzhigom/(as accessed on 12.11.2020).

At the same time, there is a need to further develop a technology which combines the benefits of using oxy-fuel burners and oxygen enhancement in melting furnaces so as, with reduced labour costs, to provide increased savings on solid fuel, to improve the quality of the end product, to increase the throughput capacity, cost effectiveness, environmental compatibility and safety of a melting furnace, specifically a shaft furnace used for the manufacture of mineral wool, while maintaining high quality of the end product.

### SUMMARY

On the basis of the aforementioned, the present invention is focussed on creating a technical solution which combines the benefits of using oxy-fuel burners and oxygen enhancement, making it possible, with reduced labour costs, to provide increased savings on solid fuel and to improve the quality of the end product, to increase the throughput capacity, flexibility, environmental compatibility and safety of a shaft furnace operational control process, specifically of a furnace used for the manufacture of mineral wool.

In order to solve said technical problem, according to one aspect of the invention, an oxy-fuel burner is proposed, said burner being designed with the ability to
be (i.e. suitable for being or adapted to be) housed within the wall of a melting furnace and comprising:
a housing, which defines an oxidizing-agent supply channel running in the longitudinal direction, from the upstream end to the downstream end of the housing, with an outlet port (i.e. an oxidizing-agent outlet port) at the downstream end of the housing,
a fuel supply channel running in the longitudinal direction of the housing, the outlet port of which fuel supply channel (i.e. the fuel outlet port) is located at the downstream end of the housing, and
an oxidant injector running in the longitudinal direction inside the fuel supply channel, the outlet port of which oxidant injector (i.e. the oxidant outlet port) is located at the downstream end of the housing, as well as an ignition and flame-control electrode running inside the oxidizing-agent supply channel and being designed with the ability to provide initial ignition of the burner and subsequent flame control, wherein said ignition and flame-control electrode is designed with the ability to be connected to a system for automatically controlling the ignition and flame control of a burner.

The proposed oxy-fuel burner can be fitted into each of the tuyeres of a melting furnace. Inasmuch as each burner contains an oxidant injector, the number of burners and oxidant injectors fitted into the furnace exceeds by a factor of two the number of burners and oxidant injectors, when compared to the solution according to which the tuyeres of a furnace are alternately equipped with burners and injectors, which makes it possible to increase the flexibility with which the mineral wool manufacturing process is controlled and to obtain a more even distribution of thermal energy around the perimeter of the furnace. Furthermore, the time spent on carrying out work related to equipping a furnace with burners of the same type is less than the time required to equip a furnace with different devices—with burners and injectors.

Also, the fact that the oxidant injector is fitted inside the burner enables the oxy-fuel burner to vary the pulsation of the burner flame, such that the thermal energy is transmitted to the centre of the melt, ensuring temperature uniformity across the entire area of the melt, which is vital for obtaining a high-quality end product during the melting of feedstock.

The presence of an automatic ignition and flame-control device makes it possible to increase the safety level of a burner and of a furnace as a whole. During operation of oxy-fuel burners which are not equipped with ignition and flame-control automation devices, “flameout” may occur, i.e. injection of fuel and oxidizing agent/oxidant without combustion, which may result in emergency situations and in damage to equipment.

The use of ignition and flame-control automation devices makes it possible to eliminate said phenomenon. Based on the results of tests carried out by the inventors, it was discovered that, where natural gas was used as the fuel, the use of ignition and flame-control automation devices in a shaft furnace, according to the invention, enables 30% of a traditional fuel (for instance, coke) to be replaced with natural gas, and increases the throughput capacity of a furnace by 10%. Therefore, the equipping of a shaft furnace with burners, according to the invention, makes it possible to replace a substantial proportion of expensive coke with another, cheaper type of fuel.

Furthermore, the use of burners according to the invention makes it possible to reduce the quantity of harmful emissions during operation of a furnace.

According to an embodiment of the invention, the ignition and flame-control electrode is an ionisation electrode.

According to an embodiment of the invention, the oxidant injector is designed with the ability to supply oxidant at a subsonic velocity.

According to an embodiment of the invention, the oxidant injector is designed with the ability to supply oxidant at a supersonic velocity.

According to an embodiment of the invention, the oxidant injector is equipped with a de Laval nozzle.

In the present context, the terms “oxidant” and “oxidizing agent” both refer to combustion oxidants, such as, for example, air, oxygen-enriched air or oxygen. The term “oxidizing agent” is used for the combustion oxidant which is supplied by means of the oxidizing-agent supply channel defined by the burner housing. The term “oxidant” is used for the combustion oxidant supplied by means of the oxidant injector which extends in the fuel-supply channel in the longitudinal direction of the housing.

According to a preferred embodiment of the invention, the concentration of oxygen in the oxidant introduced through the oxidant injector is higher than the concentration of oxygen in the oxidizing agent introduced through the oxidizing-agent supply channel.

According to an embodiment of the invention, the fuel is natural gas.

According to an embodiment of the invention, the burner contains an earth electrode positioned at a distance of 3-4 mm, in a transverse direction of the burner, from the ignition and flame-control electrode, wherein the downstream extremities of the earth electrode and the ignition and flame-control electrode are positioned at an equal distance from the downstream extremity of the housing of the burner.

According to an embodiment of the invention, the distance from the downstream extremity of the oxidant injector to the downstream extremity of the housing of the burner is equal to the outer diameter d of the oxidant injector, while the distance from the downstream extremity of the ignition and flame-control electrode to the downstream extremity of the housing of the burner is equal to 0.5d.

According to an embodiment of the invention, the oxy-fuel burner is designed with the ability to be fitted into a tuyere located in the wall of a melting furnace, wherein the distance from the downstream extremity of the housing of the burner to the downstream extremity of the tuyere is between 2D and 3D, where D is the inner diameter of the tuyere.

According to an embodiment of the invention, the oxy-fuel burner is designed with the ability to be fitted into a tuyere having a blast supply flow rate of 700-1,200 m³/hr at a temperature of 250-650° C.

According to another aspect of the invention, a system is proposed for controlling the ignition and flame control of the above-mentioned oxy-fuel burner. Said system comprises: an ignition device; a combustion-signalling device; a cut-off valves unit, designed with the ability to be connected to a gas-oxygen unit which regulates the flows of fuel, oxidizing agent/oxidant and instrument air and supplies same to the burner; and a control unit, designed with the ability to communicate with the gas-oxygen unit, the ignition device, the combustion-signalling device and the cut-off valves unit.

According to an embodiment of the invention, the ignition device is a high voltage transformer source.

According to a third aspect of the invention, a method is proposed for controlling the ignition and flame control of oxy-fuel burners, fitted in a melting furnace, using the above-mentioned system, which method comprises steps in which:
a signal is received confirming that the gas-oxygen unit has been switched on;
the number of burners requiring to be put into operation is determined;
cut-off valves in the cut-off valves unit are opened for the supply of fuel and oxidizing agent/oxidant to the selected burners;
spark ignition of the selected burners is switched on;
spark ignition is switched off;
the flame in the burners is monitored, during which monitoring process: the presence of a flame in each burner is determined, wherein, when a flame is found to be present in all the burners, operation is continued, but if a flame is found to be absent in one or more of the burners, spark ignition is switched on in the corresponding burner;
a tally is maintained of the number of unsuccessful attempts to ignite the burners, wherein, if said number is greater than a specified value, supply of gas and oxidizing agent/oxidant to the burner concerned is halted.

According to an embodiment of the invention, the specified value of the number of unsuccessful attempts to ignite the burners is equal to five.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows, in schematic form, a longitudinal section of a burner for a melting furnace according to the invention;

FIG. 2 shows a functional block diagram of a system for controlling the ignition and flame control of an oxy-fuel burner according to the invention.

### DETAILED DESCRIPTION OF PREFERRED EMBODIMENTS

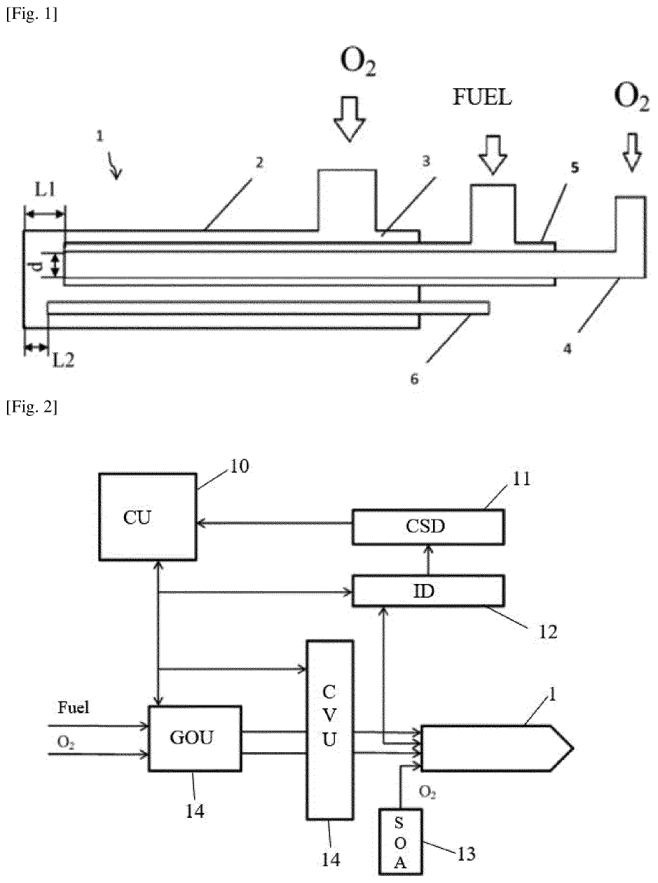

FIG. 1 shows, in schematic form, a longitudinal section of an oxy-fuel burner 1 according to the first aspect of the invention.

The oxy-fuel burner 1 is designed to be fitted into a tuyere of a melting furnace, specifically of a shaft furnace for the manufacture of mineral wool.

The burner 1 has an upstream end and a downstream end and comprises a housing 2 which runs in the longitudinal direction of the burner.

The design of the oxy-fuel burner 1 according to the invention incorporates two channels for the supply of an oxidizing agent—an oxidizing-agent supply channel 3 and a channel formed by an oxidant injector 4. The oxidizing-agent supply channel 3 is cylindrical in shape, is formed by the housing 2 of the burner, and runs from the upstream end to the downstream end of the burner, opening out into an oxidizing-agent outlet port at the downstream end of the housing.

The oxy-fuel burner 1 also comprises a fuel supply channel 5 running in the indicated longitudinal direction inside the oxidizing-agent supply channel 3.

The fuel used in the burner can be any suitable liquid or gaseous hydrocarbon fuel, for instance, natural gas.

According to the invention, the oxidant injector 4 runs inside the fuel supply channel 5 in the longitudinal direction and has an outlet port located at the downstream end of the housing.

An ignition and flame-control electrode 6 is located inside the oxidizing-agent supply channel 3, said electrode being used for initial ignition of the burner 1 and subsequent control of the flame.

This electrode can be, for instance, an ionisation electrode.

The above-mentioned ignition and flame-control electrode is designed with the ability to be connected to a system for automatically controlling the ignition and flame control of a burner, which system is described below.

The oxidant injector 4 is designed with the ability to supply oxidant at subsonic or supersonic velocity and can be equipped with a de Laval nozzle.

The burner can also comprise an earth electrode (not shown in the drawings), which is preferably positioned at a distance of 3-4 mm, in a transverse direction of the burner, from the ignition and flame-control electrode 6, wherein the downstream extremities of the earth electrode and the ignition and flame-control electrode 6 are positioned at an equal distance from the downstream extremity of the housing 2 of the burner. Furthermore, the distance L1, from the downstream extremity of the oxidant injector 4 to the downstream extremity of the housing 2 of the burner is preferably equal to the outer diameter d of the oxidant injector 4, while the distance L2 from the downstream extremity of the ignition and flame-control electrode 6 to the downstream extremity of the housing 2 of the burner is equal to 0.5d. Such values of indicated distances are required in order to ensure the reliable ignition of the burner and to reduce the likelihood of ignition not occurring.

The components of the proposed oxy-fuel burner 1 are manufactured from materials which are traditionally used in this field of technology for the manufacture of burners and ensure the necessary level of heat resistance. The burner 1 can have a cooling system of any type (using air, water or another medium as the cooling agent). However, it is important that the dimensions of the cooling system do not increase the diameter of the burner 1 beyond the required limits. Generally speaking, the outer diameter of the oxy-fuel burner 1 must not exceed a third of the diameter of the tuyere (not shown in the drawings) in which the burner is fitted.

Also, the downstream extremity of the housing 2 of the burner is preferably fitted at a distance of between 2D and 3D from the downstream extremity of the tuyere, where D is the inner diameter of the tuyere. The indicated distance is chosen to ensure failure-free operation of the device. If the burner is positioned at a lesser distance—i.e. too close to the melt zone, there is a danger that melt will ingress into the burner, while positioning the burner too far away from the melt zone will result in the melt not being fully heated and the tuyere overheating in the operating zone. Preferably, blast is supplied to the tuyere at a flow rate of 700-1,200 m³/hr at a temperature of 250-650° C. The indicated blast parameters are dictated by the specific characteristics of the production process used in the present invention for melting raw material in a melting furnace, specifically, a process which provides for the combustion of natural gas in oxygen, as well as by the specific design characteristics of the melting furnace.

The design of the oxy-fuel burner 1 enables the burner to operate in four different operating modes.

In the first operating mode, no oxidant is supplied through the oxidant injector 4. Only the oxidizing-agent supply channel 3 of the burner and the fuel supply channel are in operation.

In the second operating mode, a specified quantity of oxidant is supplied through the oxidant injector 4, at subsonic velocity, the remaining quantity of oxygen is supplied via the oxidizing agent, which is supplied through the oxidizing-agent supply channel 3.

In the third operating mode, the bulk of oxygen is supplied as oxidizing agent, which passes through the oxidizing-agent supply channel 3, while the lesser part of oxygen is supplied via the oxidant, which is supplied through the oxidant injector 4, at subsonic velocity.

In the fourth operating mode, oxidant is supplied, at supersonic velocity, through the oxidant injector 4 in order to achieve maximum penetration of the melt, present in the furnace, by the oxidant.

The oxy-fuel burners 1 according to the invention are designed to be fitted into tuyeres of a melting furnace. A furnace equipped with such oxy-fuel burners 1 has two sources of energy required for the melting of raw material. A part of the energy is energy obtained as a result of the combustion of a solid fuel (coke), while the other part is energy resulting from the combustion of a mixture of liquid or gaseous fuel with oxygen present in the oxidizing agent/oxidant.

Controlling the distribution of energy between the two energy sources, as well as the quantity of energy obtained by means of the burners in each tuyere, makes it possible to increase throughput capacity and to ensure operational flexibility and operational safety of a shaft furnace.

A pressure sensor can be fitted in each tuyere of a furnace. Such a pressure sensor can, for instance, be fitted in the forward zone of the tuyere, upstream of the burner. The positioning of the sensor can be varied depending on the design of the furnace, provided that the sensor is able to perform the function described below. Controlling the distribution of the overall flow of fuel to individual burners can be done by adjusting the air pressure in the tuyeres in which burners are fitted. Thus, in the event of clogging caused by solid material blocking the area upstream of the burner, the sensor registers a lowering of pressure, and the power of the burner is increased in order to melt the solid material and eliminate the blockage.

For instance, should clogging occur upstream of a tuyere, between 1/10 and ⅓ of the total quantity of oxygen can be supplied through the aforementioned oxidant injector 4 in order to increase the pulsation of the flame and to ensure that heat penetrates to the centre of the furnace. In effect, the oxidant injector 4 acts as an oxidant lance.

Furthermore, the supply of fuel into the fuel supply channels 5 of the burners can be controlled using parameters such as the melt temperature and the temperature inside the furnace, the temperature of exhaust gases or the water temperature in the cooling loop.

The total thermal output of the burners can be regulated by regulating the flows of fuel, the flow of oxidizing agent supplied through the oxidizing-agent supply channel 3, and the oxidant flow through the oxidant injector 4, as well by regulating the number of operating burners.

The total thermal output generated by the burners 1 can be equally distributed between all the burners 1. Also, in order to maintain the most efficient flame penetration into the furnace, some of the burners 1 can be switched off.

Controlling the order in which burners are switched on, and the output of said burners, in order to ensure uniform heat transfer into the melt, can be done using an appropriate programme.

The composition of the charge material, the quality of the coke and the quantity of liquid or gaseous fuel and the quantity and concentration of oxygen in the oxidizing agent/oxidant affects the quantity of steam and the full composition of exhaust gases. An increased concentration of carbon monoxide and hydrogen will lead to post-combustion and overheating of the furnace exit. In order to mitigate said deficiency, the burner flame is increased and decreased by adjusting the supply of fuel and oxidizing agent/oxidant.

The invention makes it possible to replace more than 30% of the energy obtained from the combustion of coke, with energy obtained from the combustion of another fuel, without significant changes to the melting process and the composition of the smoke.

Controlling the ignition and flame control of an oxy-fuel burner is carried out by means of a system for controlling the ignition and flame control of the oxy-fuel burner 1, fitted in each of the tuyeres of a furnace in which a melt of raw material is produced, specifically raw material for the manufacture of mineral wool. A functional block diagram of the aforementioned system is shown in FIG. 2.

The aforementioned system incorporates: an ignition device (ID); a combustion-signalling device (CSD); a control unit (CU); and a cut-off valves unit (CVU) having the ability to be connected to a gas-oxygen unit (GOU), which is designed to provide automatic or semi-automatic regulation of the flows of fuel, oxidizing agent/oxidant and instrument air, for the supply of same to a burner, at a specified pressure, flow and ratio of one gas to the other.

The gas-oxygen unit comprises fuel pipes, gaseous oxidizing agent pipes and instrument air pipes, fitted on a frame, as well as technical devices and pipe fittings, incorporating fuel and oxidizing agent regulating valves, fitted in series in the pipes.

The outlets of the fuel pipes and the gaseous oxidizing agent pipes are connected, via the cut-off valves unit, to the corresponding valves of the burner 1, specifically to the fuel channel 5 and to the oxidizing-agent supply channel 3.

The fuel pipe inlet of the gas-oxygen unit is connected to a fuel source. The gaseous oxygen pipe inlet is connected to an oxidizing-agent source, such as an air blower.

The inlet of the pipe supplying oxidant to the oxidant injector 4 is connected to a separate source of oxidizing agent (SOA), for instance, to a source of air in which the oxygen content exceeds 21%.

The ignition device may be a high voltage transformer source, the design of which is known per se.

The LUCh-KE flame sensor, manufactured by NPP Proma, can, for instance, be used as the combustion-signalling device.

The control unit incorporates a programmable logic controller designed with the ability to send control signals to the gas-oxygen unit, to the cut-off valves unit and to the ignition device, and to receive signals from the combustion-signalling device and the gas-oxygen unit. The control unit also controls the supply of oxidant to the oxidant injector 4.

The control unit controls each individual burner and coordinates overall operation of all the burners fitted in the furnace.

Each burner fitted in a melting furnace is equipped with the ignition and flame-control system described above.

Controlling of the ignition and flame control of burners fitted in a melting furnace, using the ignition and flame-control system, is carried out according to the following algorithm.

Start-up of the system is carried out once a signal has been received confirming that the gas-oxygen unit has been switched on. Once such a signal has been received, the number of burners which require to be activated, of all the burners fitted in the furnace tuyeres, is determined, and the cut-off valves of the respective burners, in the cut-off valves unit, are opened in order to supply fuel and oxidizing agent/oxidant to the selected burners.

After that, the spark ignition of the selected burners is switched on. To achieve this, the control unit sends a signal to the ignition devices of the selected burners for the ignition to be switched on, after receipt of which signal the ignition devices induce a spark between the ignition and flame-control electrodes and the housings of the burners, which results in combustion of the fuel-air mixture. The principle of spark ignition using, for instance, a high voltage source and an ionisation electrode, is widely known and is not examined in detail in the present application.

After a specific time period, the duration of which can be, for instance, around 3 seconds, the spark ignition is switched off and the flame is controlled.

Flame control is also carried out using the ionisation electrode of the burner. The principle of controlling a flame using an ionisation electrode is also known to persons skilled in the art.

A signal from the ionisation electrode is received by the combustion-signalling device which, in turn, emits a signal to the unit which controls the ignition and the cut-off valves unit.

The flame in each burner is monitored as part of the flame control process. If a flame is found to be present in all the burners, operation is continued.

If a flame is absent in any one of the burners, the cut-off valve of the burner is briefly closed, then the cut-off valve is reopened, and the spark ignition of this burner is switched on by transmitting a corresponding signal to the ignition device of this burner.

In the course of implementing said method, a tally is maintained of unsuccessful attempts to ignite each burner, wherein, if the number of unsuccessful attempts exceeds a specified value, the supply of gas and oxidizing agent/oxidant is halted by closing the cut-off valves, in response to a signal transmitted to the cut-off valves unit by the control device.

The number of unsuccessful attempts may be equal to, for instance, five.

Therefore, the technical solution offered by the invention combines the benefits of using oxy-fuel burners and oxygen enhancement, making it possible, with lower labour costs, to increase savings on solid fuel and to increase the quality of the end product, the throughput capacity, flexibility, environmental compatibility and safety of a process for controlling the operation of a shaft furnace, specifically a furnace used for the manufacture of mineral wool.

Legend of Abbreviations:

| | |
|---|---|
| CU | Control unit |
| CSD | Combustion-signalling device |
| ID | Ignition device |
| SOA | Source of oxidizing agent |
| CVU | Cut-off valves unit |
| GOU | Gas-oxygen unit |

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. An oxy-fuel burner adapted to be housed within a wall of a melting furnace, the oxy-fuel burner comprising:
a housing, which defines an oxidizing-agent supply channel running in a longitudinal direction, from an upstream end to a downstream end of the housing and having an oxidizing-agent outlet port at the downstream end of the housing,
a fuel supply channel extending in the longitudinal direction of the housing and having a fuel outlet port located at the downstream end of the housing,
an oxidant injector extending in the longitudinal direction inside the fuel supply channel and having an oxidant outlet port located at the downstream end of the housing, and
an ignition and flame-control electrode extending inside the oxidizing-agent supply channel and adapted to provide initial ignition of the burner and subsequent control of a burner flame, wherein said ignition and flame-control electrode is adapted to be connected to a system for automatically controlling the ignition and flame control of a burner.

17. The oxy-fuel burner according to claim 16, wherein the ignition and flame-control electrode is an ionisation electrode.

18. The oxy-fuel burner according to claim 16, wherein the oxidant injector is adapted to supply oxidant at a subsonic velocity.

19. The oxy-fuel burner according to claim 16, in which the oxidant injector is adapted to supply oxidant at a supersonic velocity.

20. The oxy-fuel burner according to claim 19, wherein the oxidant injector is equipped with a de Laval nozzle.

21. The oxy-fuel burner according to claim 16, wherein the concentration of oxygen in the oxidant introduced through the oxidant injector is higher than the concentration of oxygen in the oxidizing agent introduced through the oxidizing-agent supply channel.

22. The oxy-fuel burner according to claim 16, wherein the fuel is natural gas.

23. The oxy-fuel burner according to claim 16, wherein said burner contains an earth electrode positioned at a distance of 3-4 mm, in a transverse direction, from the ignition and flame-control electrode, wherein the downstream extremities of the earth electrode and the ignition and flame-control electrode are positioned at an equal distance from the downstream extremity of the housing of the burner.

24. The oxy-fuel burner according to claim 16, wherein the distance (L1) from the downstream extremity of the oxygen injector to the downstream extremity of the housing of the burner is equal to the outer diameter (d) of the oxidant injector, while the distance (L2) from the downstream extremity of the ignition and flame-control electrode to the downstream extremity of the housing of the burner is equal to 0.5d.

25. The oxy-fuel burner according to claim 16, adapted to be fitted into a tuyere located in the wall of a melting furnace, wherein the distance from the downstream extremity of the housing of the burner to the downstream extremity of the tuyere is between 2D and 3D, where D is the inner diameter of the tuyere.

26. The oxy-fuel burner according to claim 25, adapted to be fitted into a tuyere having a blast supply flow rate of 700-1,200 m³/hr at a temperature of 250-650° C.

27. A system for automatically controlling the ignition and flame control of the oxy-fuel burner according to claim 1, wherein said system comprises: an ignition device; a combustion-signalling device; a cut-off valves unit, designed with the ability to be connected to a gas-oxygen unit which regulates the flows of fuel, oxidizing agent, oxidant and instrument air and supplies same to the burner; and a control unit designed with the ability to communicate with the gas-oxygen unit, the ignition device, the combustion-signalling device and the cut-off valves unit.

28. The system according to claim 27, in which the ignition device is a high voltage transformer source.

29. A method for controlling the ignition and flame control of oxy-fuel burners, fitted in a melting furnace, using the system according to claim 16, which method comprises steps in which:
a signal is received confirming that the gas-oxygen unit has been switched on;
the number of burners requiring to be put into operation is determined;
cut-off valves in the cut-off valves unit are opened for the supply of fuel oxidizing agent and oxidant to the selected burners;
spark ignition of the selected burners is switched on;
spark ignition is switched off;
the flame in the burners is monitored, during which monitoring process:
the presence of a flame in each burner is determined, wherein, when a flame is found to be present in all the burners, operation is continued, but if a flame is found to be absent in one or more of the burners, spark ignition is switched on in the corresponding burner;
a tally is maintained of the number of unsuccessful attempts to ignite the burners, wherein, if said number is greater than a specified value, supply of gas, oxidizing agent and oxidant to the corresponding burner is halted.

30. The method according to claim 29, in which the specified value of the number of unsuccessful attempts to ignite the burners is equal to five.
